(19) United States
(12) Patent Application Publication
(10) Pub. No.: US 2025/0061531 A1
(43) Pub. Date: Feb. 20, 2025

(54) Mobile Tax Office

(71) Applicant: Millicent Dotson, Indianapolis, IN (US)

(72) Inventor: Millicent Dotson, Indianapolis, IN (US)

(21) Appl. No.: 18/799,757

(22) Filed: Aug. 9, 2024

Related U.S. Application Data
(60) Provisional application No. 63/520,438, filed on Aug. 18, 2023.

(51) Int. Cl. G06Q 90/00; G06Q 40/10

(52) U.S. Cl. CPC G06Q 90/00; G06Q 40/10

(57) ABSTRACT

The present invention is a mobile tax office. The mobile tax office provides workers with a unit equipped with all tax filing needs while a client goes about their day at work or other errands. The mobile tax office provides users with a device that can provide in-person assistance to file taxes. To accomplish this the mobile tax office has wheels, a housing, a vehicle attachment system, entries, an electrical system, an entry kiosk, workstations, and a printing station. The electrical system has a generator, an HVAC system, an internal power panel, a plurality of lights, and a plurality of outlets. This ensures that workers can prepare taxes in a mobile unit that is properly heated, cooled, ventilated, and equipped with necessary computing devices. The wheels ensure that the mobile tax office is capable of transporting to various areas and is not confined to one location.

### FIELD OF THE INVENTION

The present invention relates generally to a mobile tax office. More specifically, the present invention is a device that allow for users to file their taxes with a professional without having to enter a brick-and-mortar tax office.

### BACKGROUND OF THE INVENTION

Tax filing offices are dedicated locations or facilities where individuals and businesses can prepare and submit their tax returns to the government. These offices provide essential services during tax seasons, assisting taxpayers in accurately completing their tax forms and fulfilling their legal obligations. Staffed by trained professionals, tax filing offices offer expert guidance on tax codes, deductions, credits, and exemptions, ensuring that taxpayers take advantage of available benefits when complying with tax regulations.

An objective of the present invention is to provide users with a mobile tax office, to help individuals file their taxes without having to travel. The present invention intends to provide users with a device that can provide propel with in person tax assistance. In order to accomplish that, a preferred embodiment of the present invention comprises a plurality of wheels 1, a vehicle attachment system 2, a plurality of entries 3, an electrical system 4, an entry kiosk 5, and a plurality of stations. Further, the entry kiosk 5 allows people to fill out their preliminary information to lower the wait time when getting assistance from the present invention. Thus, the present invention is a mobile tax office that provides people with an in-person tax filing service without needing to travel to a brick-and-mortar tax filing office.

The present invention is a mobile tax office that offers in-person assistance for specific tax-related inquiries. The present invention seeks to provide users with a device that can simplify the tax filing experience and promote accurate tax reporting. In order to accomplish this the present invention comprises a plurality of wheels 1 and a vehicle attachment system 2 that allows the present invention to be easily transported to various locations. Further, the plurality of entries 3 allows for people to easily enter and leave the present invention. Additionally, the electrical system 4 provides the present invention with power and lighting. Further, the entry kiosk 5 allows a user to enter their preliminary information before meeting their tax professional. Furthermore, the plurality of stations a provide an area where a tax professional can work and file taxes for a client. Thus, the present invention is a mobile tax office that provides people with an in-person tax filing service without needing to travel to a brick-and-mortar tax filing office.

### BRIEF DESCRIPTION OF THE DRAWINGS

FIG. 1 is a top front right perspective view of the present invention with the doors closed.

FIG. 2 is a top front left perspective view of the present invention.

FIG. 3 is a bottom rear right perspective view of the present invention with the doors open.

FIG. 4 is a bottom rear left perspective view of the present invention.

FIG. 5 is a rear view of the present invention.

FIG. 6 is a front view of the present invention.

FIG. 7 is a right-side view of the present invention.

FIG. 8 is a left-side view of the present invention.

FIG. 9 is a top view of the present invention.

FIG. 10 is a bottom view of the present invention.

FIG. 11 is a block diagram of the present invention.

### DETAIL DESCRIPTIONS OF THE INVENTION

All illustrations of the drawings are for the purpose of describing selected versions of the present invention and are not intended to limit the scope of the present invention.

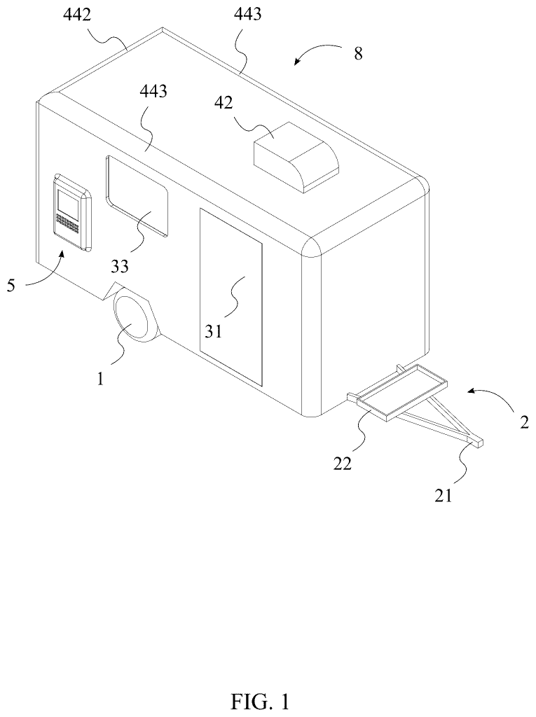

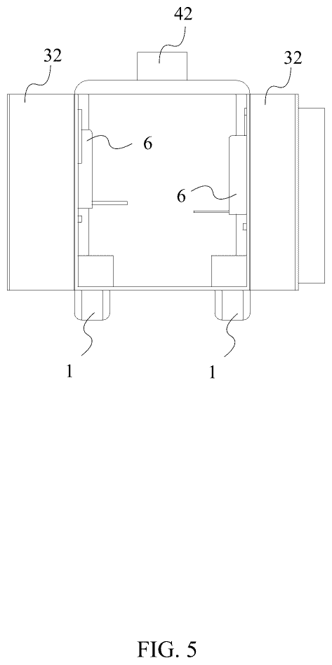

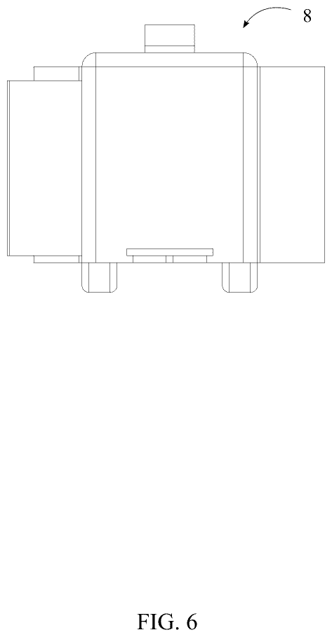

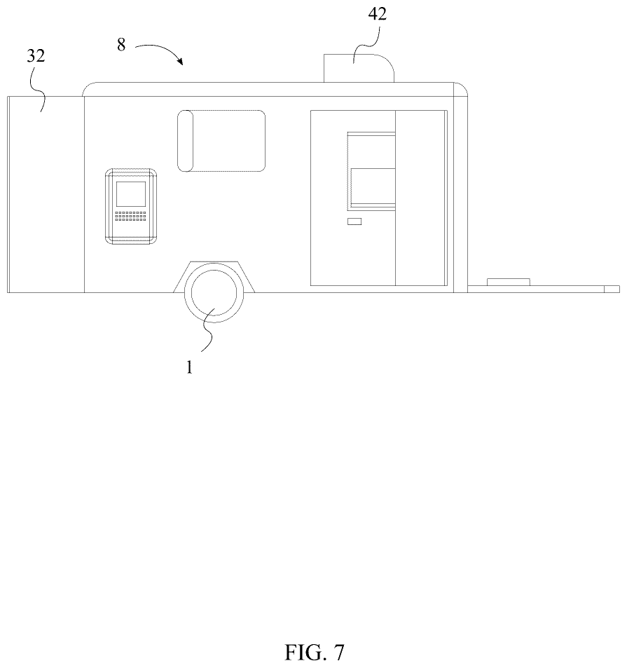

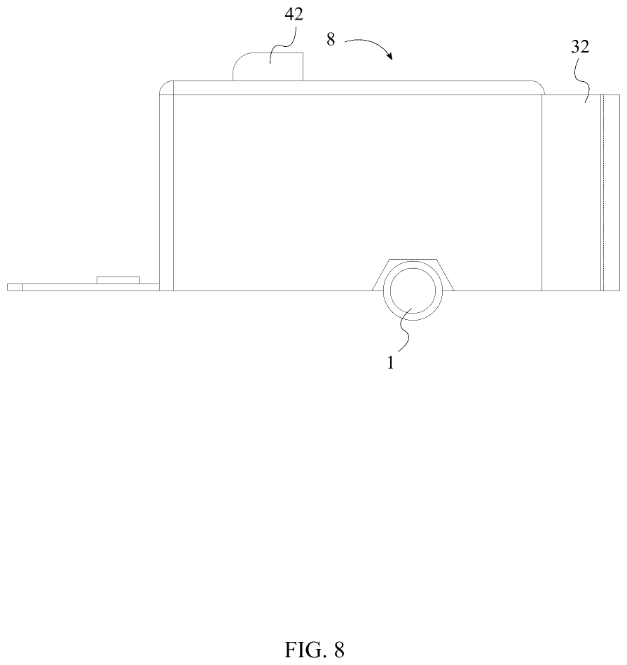

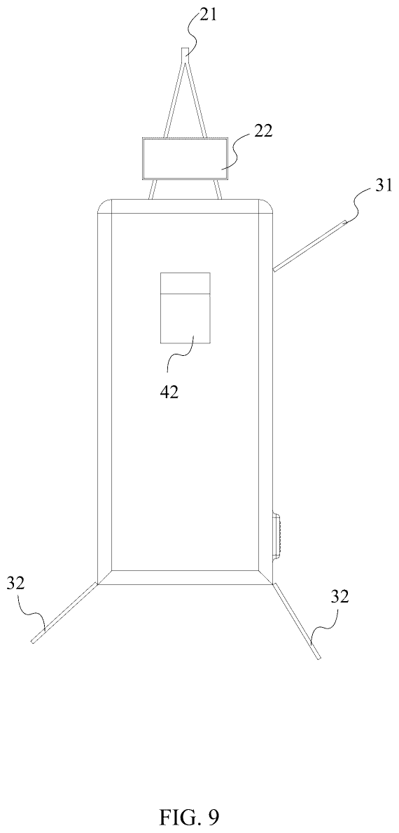

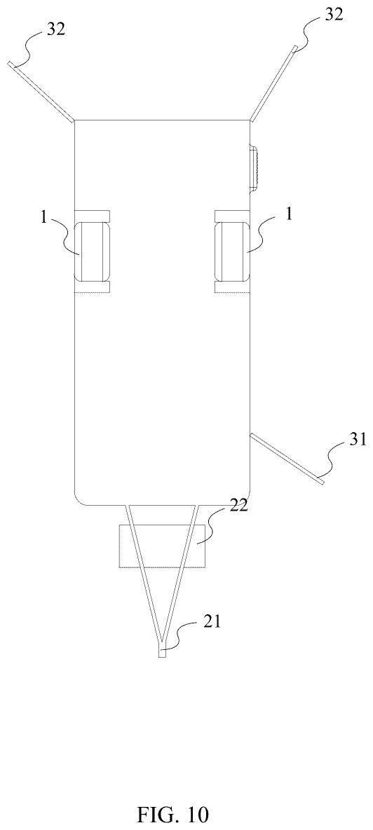

As shown in FIG. 1-11, the present invention is a mobile tax office. An objective of the present invention is to provide users with a tax filing while the client goes about their day at work or other errands. The present invention intends to provide users with a device that can provide in-person assistance to file taxes. To accomplish this the present invention comprises a plurality of wheels 1, a housing 8, a vehicle attachment system 2, a plurality of entries 3, an electrical system 4, an entry kiosk 5, a plurality of workstations 6, and a printing station 7. The electrical system 4 comprises a generator 41, an HVAC system 42, an internal power panel 43, a plurality of lights 44, and a plurality of outlets 45. As a result, the electrical system 4 ensures that workers can prepare taxes in a mobile unit. The plurality of wheels 1 positions along the outer bottom side of the housing 8. Consequently, the plurality of wheels 1 contacts the ground below the housing 8. The vehicle attachment system 2 affixes to the front side of the housing 8. Accordingly, the housing 8 is capable of being pulled from the front via the vehicle attachment system 2. The plurality of entries 3 integrates along the outer surface of the housing 8. Thus, the plurality of entries 3 enables clients and workers to enter the housing 8 though an opening. The electrical system 4 integrates into the housing 8. So, the electrical system 4 traverses through the housing 8 forming electrical connections as needed. The plurality of workstations 6 positions within the housing 8. As a result, the plurality of workstations 6 is sheltered within the housing 8. The printing station 7 positions within the housing 8 offset the plurality of workstations 6. Consequently, the printing station 7 is sheltered within the housing 8 and does not interfere with the plurality of workstations 6. The printing station 7 is a standard table that is affixed to the floor of the housing 8 via a plurality of fasteners and a series of bolts.

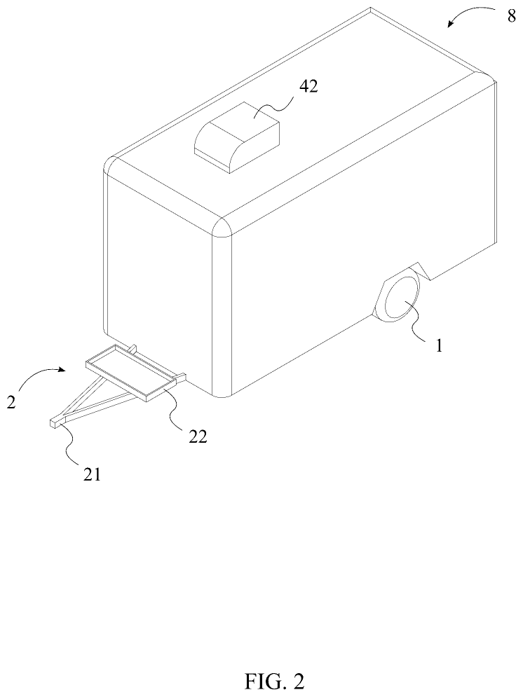

In reference to FIG. 2, the plurality of wheels 1 is mechanically coupled to the housing 8. Accordingly, the plurality of wheels 1 rotate around a central axis. The plurality of wheels 1 enables the housing 8 to move along a road. The vehicle attachment system 2 mechanically couples the housing 8 to a vehicle. Thus, the vehicle attachment system 2 enables the housing 8 to be moved by a vehicle. The vehicle attachment system 2 is capable of enabling the housing 8 to be pulled by a vehicle. The vehicle attachment system 2 further comprises a trailer hitch 21 and a generator stand 22. The trailer hitch 21 is capable of mechanically coupling the housing 8 to a vehicle hitch. So, the trailer hitch 21 secures the housing 8 to a vehicle. This design allows for the housing 8 to be pulled by a vehicle of varying shapes and sizes. The generator stand 22 secures along the top side of the trailer hitch 21. As a result, the generator stand 22 is a rectangular platform that is designed to hold a generator 41. The generator stand 22 receives and secures a generator 41. This design ensures that the generator 41 stays in place on the generator stand 22 while the housing 8 is parked.

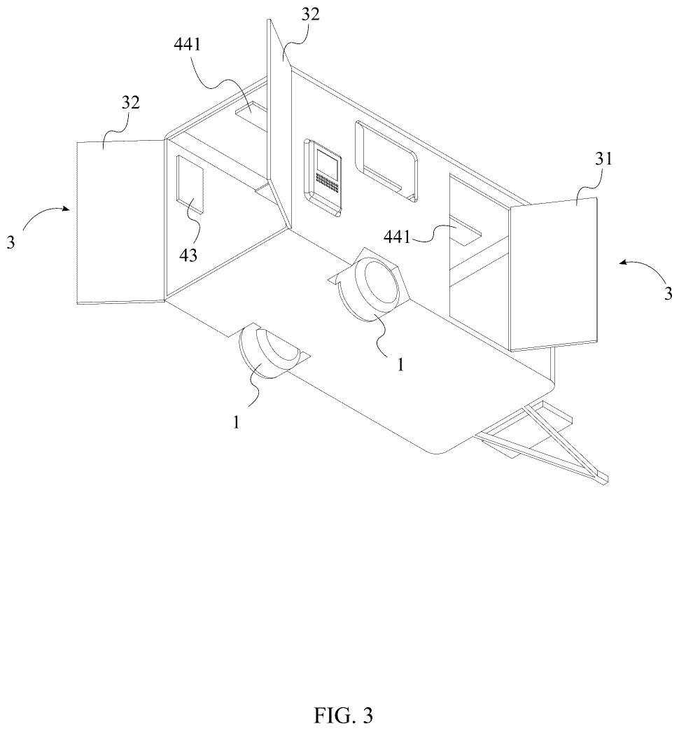

In reference to FIG. 3, the plurality of entries 3 further comprises a side door 31, a plurality of rear doors 32, and a window. The side door 31 is positioned along the right side of the housing 8. Consequently, the side door 31 forms an opening into the housing 8. The plurality of rear doors 32 is positioned along the rear side of the housing 8. Accordingly, the plurality of rear doors 32 forms an opening along the rear side of the housing 8. The plurality of rear doors 32 is secured to the housing 8 via a hinge and allows the plurality of rear doors 32 to swing open, forming the opening. The side door 31 and plurality of rear doors 32 opens to enable clients and workers to enter the housing 8. Thus, the clients and workers can enter and exit the housing 8 as needed throughout the preparation of taxes. The window integrates along the side of the housing 8 offset the side door 31. The window slides open to receive natural light and air within the housing 8. So, the window forms another opening along the housing 8 that provides workers and clients with access to the outside environment. In an alternative embodiment the window is a plurality of windows 33 and designed with an identical window on the opposite side of the present invention which slides open and functions the same way.

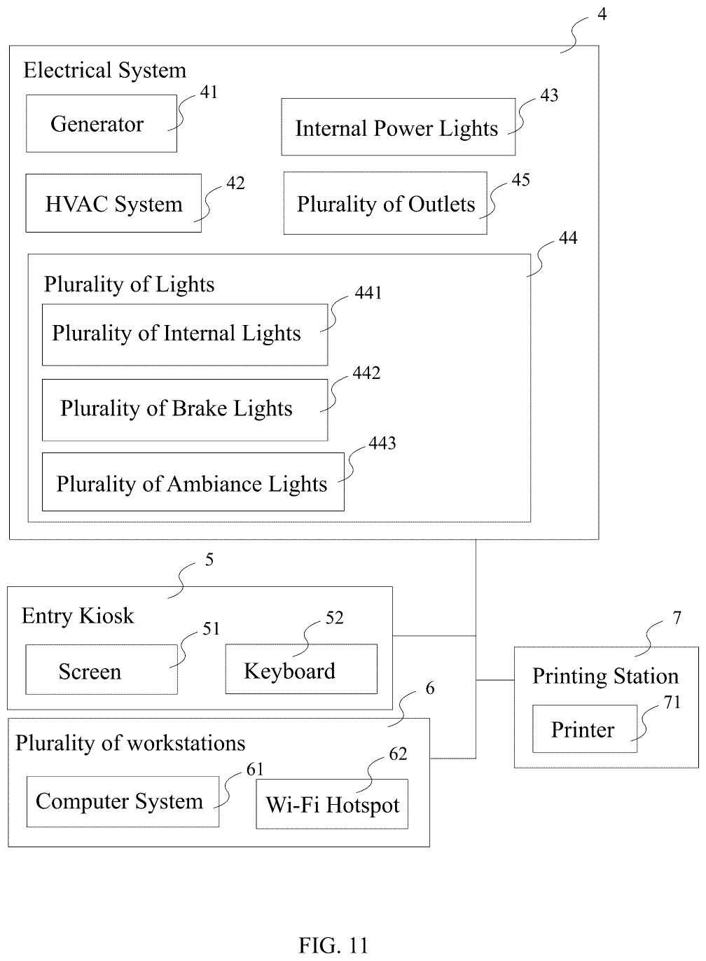

In reference to FIG. 11, the generator 41 is electrically coupled to the internal power panel 43. The generator 41 provides electricity. As a result, the generator 41 provides electricity to the internal power panel 43 and the connected components. The internal power panel 43 electrically couples to the HVAC system 42, the plurality of lights 44, the plurality of outlets 45, and the entry kiosk 5. Consequently, the internal power panel 43 powers the connected components. The internal power panel 43 is designed with a plurality of switches and controls to allow an individual to control the flow of electricity leaving the internal power panel 43.

Further, the HVAC system 42 integrates along the top side of the housing 8 as seen in FIG. 2. Accordingly, the HVAC system 42 is positioned out of the way of other electrical components. The HVAC system 42 provides heating, cooling and ventilation to the inside of the housing 8. Thus, the HVAC system 42 connects the outdoor environment to the environment within the housing 8, pulling hot, cold, and stale air out of the environment within the housing 8.

Further, the plurality of outlets 45 integrates along the inside surface of the housing 8. So, the plurality of outlets 45 are easily accessible by the workers positioned within the housing 8. The internal power panel 43 integrates along the inside surface of the housing 8 as shown in FIG. 3. As a result, the internal power panel 43 is easily accessible and controllable by a worker within the housing 8. The internal power panel 43 controls the flow of electricity to the electrically coupled components. The plurality of lights 44 further comprises a plurality of internal lights 441, a plurality of brake lights 442, and a plurality of ambiance lights 443.

Furthermore, the plurality of internal lights 441 integrates along the top side inside of the housing 8 as seen in FIG. 3. Consequently, the plurality of internal lights 441 provide ample lighting within the housing 8 to ensure workers can properly prepare taxes. The plurality of brake lights 442 integrates along the rear side of the housing 8. Accordingly, the plurality of brake lights 442 couples to the vehicle breaking system and illuminates as the vehicle breaks to indicate that the vehicle and the coupled housing 8 are slowing down while in transit. The plurality of brake lights 442 emits a red colored light that corresponds with the brake lights of the attached vehicle. The plurality of ambiance lights 443 integrates along the upper side of the housing 8. Thus, the plurality of ambiance lights 443 illuminate the outside of the housing 8. The plurality of ambiance lights 443 is designed to emit a yellow and orange color to enhance the visibility of the housing 8 in dark areas.

In reference to FIG. 1, the entry kiosk 5 is a computing system with a GUI. So, the kiosk is capable of running computing and processing software to allow the entry kiosk 5 to obtain, record, store and transfer data. The entry kiosk 5 is designed to allow clients to sign-up for services, enter general information, scan documents, and receive estimated wait times. The entry kiosk 5 enables clients to enter preliminary information to lower wait times. As a result, the clients can enter information before being seen by a worker, reducing the amount of time it takes for a worker to prepare the taxes for the client. The entry kiosk 5 integrates along the side of the housing 8 offset the side door 31. Consequently, the entry kiosk 5 is accessible for a client from the outside of the housing 8. The entry kiosk 5 comprises a screen 51 and a keyboard 52. The entry kiosk 5 transmits the entered data to the plurality of workstations 6. Once the client has entered the relevant information, the information is then stored and sent to the plurality of workstations 6 where a worker can retrieve the information and process the information for the client's tax preparations.

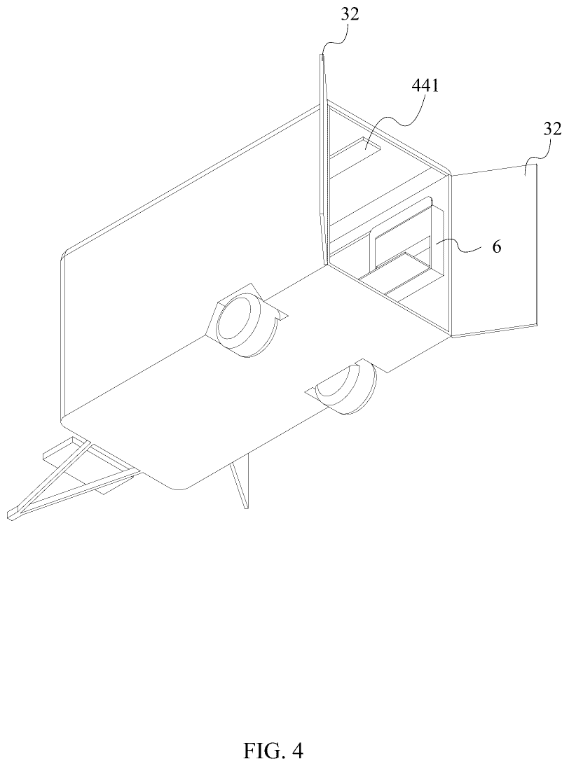

In reference to FIG. 4, the plurality of workstations 6 secures within the housing 8. Each of the plurality of workstations 6 are foldable desks attached to the inner wall of the housing 8. Furthermore, a latch secures each of the plurality of workstations 6 up against the wall while the housing 8 is in transit or more room within the housing 8 is needed. Accordingly, the plurality of workstations 6 are designed with fasteners to hold the plurality of workstations 6 to the floor of the inside of the housing 8. This design prevents the plurality of workstations 6 from shifting out of place while the housing 8 is being transported. Each of the plurality of workstations 6 further comprises a computer system 61, a Wi-Fi hotspot 62, and a chair.

Further, the computer system 61 prepares taxes for clients. Thus, the computer system 61 utilizes software for tax preparation. The Wi-Fi hotspot 62 provides a network for the computer system 61 and mobile devices. This design allows for the computer system 61 to access a network without being physically connected to the Wi-Fi hotspot 62. The chair is positioned offset the computer system 61 and enables a worker to prepare taxes at each of the plurality of workstations 6. Further, the printing station 7 further comprises a printer 7. The printer π electronically communicates with the computer system 61 as seen in FIG. 11. As a result, the printer 7 exchanges information with the computer system 61 to print documents as needed. The printer 7 receives data from the computer system. With all the components working in tandem with each other it can be seen that the present invention is a mobile tax office that provides people with an in-person tax filing service without needing to travel to a brick-and-mortar tax filing office.

Although the invention has been explained in relation to its preferred embodiment, it is to be understood that many other possible modifications and variations can be made without departing from the spirit and scope of the invention as hereinafter claimed.

What is claimed is:

1. A mobile tax office comprising:
a plurality of wheels;
a housing;
a vehicle attachment system;
a plurality of entries;
an electrical system;
an entry kiosk;
a plurality of workstations;
a printing station;
the electrical system comprising a generator, an HVAC system, an internal power panel, a plurality of lights, and a plurality of outlets;
the plurality of wheels positioning along the outer bottom side of the housing;
the vehicle attachment system affixing to the front side of the housing;
the plurality of entries integrating along the outer surface of the housing;
the electrical system integrating into the housing;
the plurality of workstations positioning within the housing; and
the printing station positioning within the housing offset the plurality of workstations.

2. The mobile tax office as claimed in claim 1 comprising:
the plurality of wheels being mechanically coupled to the housing;
the plurality of wheels enabling the housing to move along a road;
the vehicle attachment system being capable of mechanically coupling the housing to a vehicle; and
the vehicle attachment system being capable of enabling the housing to be pulled by a vehicle.

3. The mobile tax office as claimed in claim 1 comprising:
the vehicle attachment system further comprising a trailer hitch and a generator stand;
the trailer hitch being capable of mechanically coupling the housing to a vehicle hitch;
the generator stand securing along the top side of the trailer hitch; and
the generator stand receiving and securing a generator.

4. The mobile tax office as claimed in claim 1 comprising:
the plurality of entries further comprising a side door, a plurality of rear doors, and a window;
the side door being positioned along the right side of the housing;
the plurality of rear doors being positioned along the rear side of the housing;
the side door and plurality of rear doors opening to enable clients and workers to enter the housing;
the window integrating along the side of the housing offset the side door; and
the window sliding open to receive natural light and air within the housing.

5. The mobile tax office as claimed in claim 1 comprising:
the generator being electrically coupled to the internal power panel;
the generator providing electricity; and
the internal power panel electrically coupling to the HVAC system, the plurality of lights, the plurality of outlets, and the entry kiosk.

6. The mobile tax office as claimed in claim 5 comprising:
the HVAC system integrating along the top side of the housing; and
the HVAC system providing heating, cooling and ventilation to the inside of the housing.

7. The mobile tax office as claimed in claim 5 comprising:
the plurality of outlets integrating along the inside surface of the housing;
the internal power panel integrating along the inside surface of the housing;
the internal power panel controlling the flow of electricity to the electrically coupled components; and
the plurality of lights further comprising a plurality of internal lights, a plurality of brake lights, and a plurality of ambiance lights.

8. The mobile tax office as claimed in claim 7 comprising:
the plurality of internal lights integrating along the top side inside of the housing;
the plurality of brake lights integrating along the rear side of the housing; and
the plurality of ambiance lights integrating along the upper side of the housing.

9. The mobile tax office as claimed in claim 1 comprising:
the entry kiosk being a computing system with a GUI;
the entry kiosk enabling customers to enter preliminary information to lower wait times;
the entry kiosk integrating along the side of the housing offset the side door;
the entry kiosk comprising a screen and a keyboard; and
the entry kiosk transmitting the entered data to the plurality of workstations.

10. The mobile tax office as claimed in claim 1 comprising:
the plurality of workstations securing within the housing; and
each of the plurality of workstations further comprising a computer system, and a Wi-Fi hotspot.

11. The mobile tax office as claimed in claim 10 comprising:
the computer system preparing taxes for customers; and
the Wi-Fi hotspot providing a network for the computer system and mobile devices.

12. The mobile tax office as claimed in claim 10 comprising:
the printing station further comprising a printer;
the printer electronically communicating with the computer system; and
the printer receiving data from the computer system.

13. A mobile tax office comprising:
a plurality of wheels;
a housing;
a vehicle attachment system;
a plurality of entries;
an electrical system;
an entry kiosk;
a plurality of workstations;
a printing station;
the electrical system comprising a generator, an HVAC system, an internal power panel, a plurality of lights, and a plurality of outlets;
the plurality of wheels positioning along the outer bottom side of the housing;
the vehicle attachment system affixing to the front side of the housing;
the plurality of entries integrating along the outer surface of the housing;
the electrical system integrating into the housing;
the plurality of workstations positioning within the housing;
the printing station positioning within the housing offset the plurality of workstations;
the plurality of wheels being mechanically coupled to the housing;
the plurality of wheels enabling the housing to move along a road;
the vehicle attachment system being capable of mechanically coupling the housing to a vehicle; and
the vehicle attachment system being capable of enabling the housing to be pulled by a vehicle.

14. The mobile tax office as claimed in claim 13 comprising:
the vehicle attachment system further comprising a trailer hitch and a generator stand;
the trailer hitch being capable of mechanically coupling the housing to a vehicle hitch;
the generator stand securing along the top side of the trailer hitch; and
the generator stand receiving and securing a generator.

15. The mobile tax office as claimed in claim 13 comprising:
the plurality of entries further comprising a side door, a plurality of rear doors, and a window;
the side door being positioned along the right side of the housing;
the plurality of rear doors being positioned along the rear side of the housing;
the side door and plurality of rear doors opening to enable clients and workers to enter the housing;
the window integrating along the side of the housing offset the side door; and
the window sliding open to receive natural light and air within the housing.

16. The mobile tax office as claimed in claim 13 comprising:
the generator being electrically coupled to the internal power panel;
the generator providing electricity; and
the internal power panel electrically coupling to the HVAC system, the plurality of lights, the plurality of outlets, and the entry kiosk.

17. The mobile tax office as claimed in claim 16 comprising:
the HVAC system integrating along the top side of the housing; and
the HVAC system providing heating, cooling and ventilation to the inside of the housing.

18. The mobile tax office as claimed in claim 16 comprising:
the plurality of outlets integrating along the inside surface of the housing;
the internal power panel integrating along the inside surface of the housing;
the internal power panel controlling the flow of electricity to the electrically coupled components;
the plurality of lights further comprising a plurality of internal lights, a plurality of brake lights, and a plurality of ambiance lights;
the plurality of internal lights integrating along the top side inside of the housing;
the plurality of brake lights integrating along the rear side of the housing; and
the plurality of ambiance lights integrating along the upper side of the housing.

19. The mobile tax office as claimed in claim 13 comprising:
the entry kiosk being a computing system with a GUI;
the entry kiosk enabling customers to enter preliminary information to lower wait times;
the entry kiosk integrating along the side of the housing offset the side door;
the entry kiosk comprising a screen and a keyboard; and
the entry kiosk transmitting the entered data to the plurality of workstations.

20. The mobile tax office as claimed in claim 13 comprising:
the plurality of workstations securing within the housing;
each of the plurality of workstations further comprising a computer system, and a Wi-Fi hotspot;
the computer system preparing taxes for customers;
the Wi-Fi hotspot providing a network for the computer system and mobile devices;
the printing station further comprising a printer;
the printer electronically communicating with the computer system; and
the printer receiving data from the computer system.
